(19) United States
(12) Patent Application Publication
(10) Pub. No.: US 2009/0124348 A1
(43) Pub. Date: May 14, 2009

(54) Electronic dice control in gaming

(76) Inventors: Mark L. Yoseloff, Henderson, NV (US); R. Brooke Dunn, Henderson, NV (US); Lindsay Roberts, Mosman (AU); Sergei Ivanoff, Werrington (AU)

Correspondence Address: Mark A> Litman and Associates, P.A.;York Business Center, 3209 w. 76th Street, Suite 205, Edina, MN, 55435, US

(21) Appl. No.: 11/983,480

(22) Filed: Nov. 9, 2007

(51) Int. Cl. G06F 17/00; A63F 9/04

(52) U.S. Cl. 463/22; 463/25; 463/37; 273/146

(57) ABSTRACT

An electronic video gaming system enables play of a dice wagering game. The system has a processor, a video screen, player credit controls or wager input system, and touch functions for player input on the video screen. After at least one player has placed a wager in a wagering game, at least one player at the video game is designated as a shooter, and while a virtual image of dice appears on a screen, the virtual image of the dice is sensitive to contact and hand movement of a player in contact with the screen of the shooter. The image of a dice roll is initiated in the wagering game by the hand movement of the designated shooter.

### BACKGROUND OF THE INVENTION

1. Field of the Invention

The present technology relates to gaming, particularly gaming on a system with a video display of gaming elements, more particularly to gaming systems using virtual dice, and to gaming systems using virtual displays of dice wherein the gaming system has player input and player controls.

2. Background of the Art

It is known in the art to provide simulations of the game of craps.

Although the disclosure of U.S. Pat. Nos. 7,032,901; 6,481,713 describes the use of a start button to initiate a dice roll.

Perrie also describes touching a “hold” button or touching the area representing virtual dice on a touch screen to prevent a roll of some or all of the dice from taking place. This action deactivates the dice.

Gamers tend to be superstitious individuals, believing heavily in luck and are often seeking some form of input into their play that will influence or increase their luck, such as blowing on dice, rubbing dice along a playing surface, exhorting other players to cheer and shout, or positioning dice in a particular pattern or number arrangement before throwing the dice, such as picking up dice with a number combination of a count of 9 when the Point is 9. These characteristics have been missing from all electronic formats of dice games.

The most popular dice game for wagering in casinos is Craps. The game of craps has generally consistent rules through the world. Those rules are described in Published U.S. Patent Application No. 20060043678 (Golden) which is incorporated herein in its entirety by reference for its disclosure of rules and game content for Craps and Craps-type casino table wagering games.

### SUMMARY OF THE INVENTION

A system, apparatus and method of playing a video dice game is described. An electronic video gaming system may comprise at least a processor, a player video screen, player credit controls or wager input system, and touch functions (or buttons) for player input on the video screen. After a player designated as a shooter has placed a wager in a wagering game, and while a virtual image of dice appears on a screen, the virtual image of the dice is sensitive to contact and hand movement of a player (and/or button input control) on the screen to initiate an image of a dice roll in the wagering game. The electronic video gaming system may have the virtual image of the dice also sensitive to contact and hand movement or buttons of a player to adjust numbers appearing on the virtual image of the dice prior to the dice roll in the wagering game. The preferred hand movement to initiate an image of a dice roll to which the touch functions are sensitive comprises sliding a player's hand across the video screen.

A method of playing a video wagering game is described where dice rolls are displayed as a game event. The game is played by a player placing a wager on the video dice game. An image is provided of at least one die on a touch sensitive video screen. The image of the at least one die is contacted on the video screen by a player's hand. The contact is moved (the player's hand is moved) to initiate a rolling or throwing response on the dice, with the image of the at least one die initiated to provide an image of the at least one die being cast, rolled or thrown. Using a resulting number on a virtual image of the cast die after it comes to rest is a game determining outcome.

### BRIEF DESCRIPTION OF THE FIGURES

FIG. 1 shows a perspective view of a gaming table with individual player monitors distributed about the table, each of the individual player monitors having player input systems.

FIG. 2 shows a screen shot on a player's monitor showing dice before being virtually cast.

FIG. 3 shows a screen shot on a player's monitor showing dice in contact with a virtual hand mimicking contact by a player's hand before the dice are virtually cast.

FIG. 4 shows a real player's hand manipulating a stationary or preliminary position of the dice prior to casting the dice.

FIG. 4a is a schematic diagram of an example of the present invention.

FIG. 5 shows a hand moving in contact with a touch screen on a player's monitor and initiating movement of the dice.

FIG. 6 shows a perspective view of an alternate gaming table with individual player monitors and a common display.

### DETAILED DESCRIPTION OF THE INVENTION

An electronic video gaming system having processor driven play enables play of a simulated dice wagering game. Although a preferred format involves the wagering of currency or its equivalents, the game may be played in a practice play format, such as on a personal computer, personal game platform, cell phone game, or a hand-held device, for example. The game of the present invention may also be played in a wireless gaming format, a remote gaming format, as an internet gaming game and in any other known format. The system has a processor, a video screen, player credit controls or wager input system, and touch functions for player input on the video screen. After at least one player has placed a wager in a wagering dice game, at least one player at the video game is designated as a shooter, and while a virtual image of dice appears on a screen, the virtual image of the dice is sensitive to contact and hand movement of a player in contact with the screen of the shooter. The image of a dice roll is initiated in the wagering game by the hand movement of the designated shooter.

The designation as shooter may be accomplished in a variety of ways, the preferred format being as close as possible to designation of a shooter at a normal craps game. In one embodiment, the first (and if only) player to enter a table is designated as a first shooter. The right to be the shooter (and therefore control the virtual throwing of the dice) continues until a player leaves the table (seldom done while continuing a successful roll) or until the shooter sevens-out, that is, rolls a number count of seven while a Point has been established. The right to be the shooter then passes clockwise to a next player at the table, who may become the shooter or decline to be the shooter. The shooter rights are generally governed by the rules of public domain craps. The touch screen controls in one embodiment allow a shooter to pass the right to the next player in clockwise order.

A system, apparatus and method of playing a video dice game is enabled according to the present technology. A stand-alone electronic video gaming system may be used to practice the present technology. A suitable stand-alone gaming machine comprises at least a processor (with memory, video control system and software, game rules, credit/wager accounting, and the like as further described herein) at least one video screen for a player, player credit controls or wager input system, and button and/or preferably touch functions for player input onto the video screen.

After a player is designated as a shooter (which on a single player machine is the only player) and has placed a wager in a wagering game, a virtual image of at least one die and preferably two dice appears on a screen. In a preferred embodiment, the virtual image of the dice is sensitive to contact and hand movement of a player to initiate a visual enactment or video display of dice being cast, as is done in a craps game. The touch screen controls enable the player to position the dice prior to the roll, roll the dice and aim the dice in a desired direction.

The electronic video gaming system may provide a virtual image of the dice that is sensitive to contact and hand movement, or buttons of a player, to adjust numbers appearing on the virtual image of the dice prior to the dice roll in the wagering game. The button input control would preferably only be used to establish or allow the player to set the dice in a visually observable starting display of numbers and not to initiate an image of a dice roll in the wagering game. However, a control panel with push button controls and/or a joystick or “track ball” could be used as an alternative to touch screen controls to accomplish those functions. The preferred play of the system is to use touch screen controls so that actual hand movement of the player designated as the shooter touch screen initiates a dice roll. The touch functions that are movement sensitive preferably comprise sliding a player's hand across the video screen in a desired direction.

The preferred method of play is for the system to operate on a multiplayer platform, with multiple touch screen monitors spaced about a table (which may be smaller than, the same size as, or larger than a standard dice game table, such as the craps table. In this format, although every player may view the dice before being thrown, only one screen will be activated to enable a player at that screen (the shooter position) to be able to control the virtual movement of the dice in a round.

A method of playing a video wagering game is described where virtual dice are displayed as determining a game event. The game is played by a player placing a wager on the video dice game. An image is provided of at least one die on a touch sensitive video screen. The image of the at least one die is contacted on the video screen by a player's hand. The contact is moved (the player's hand is moved) across touch screen controls to initiate a rolling or throwing response on the dice with the image of the at least one die initiated to provide an image of the at least one die being positioned, cast, rolled or thrown. Using a resulting number on a virtual image of the cast die after it comes to rest is defined as a game determining outcome.

At least one of the following elements are available as elements of the novel electronic technology in an electronic game where dice (virtual dice) are used to display the results of random number generation of events (the roll of a dice):

the image of dice can be manipulated (in a pre-roll or roll action) by player hand contact with a touch screen;

the manipulation may be actuation (virtual throwing) of the roll of the dice by player hand contact and movement on the screen; and

the manipulation may also include presetting numbers on the dice prior to the virtual throwing of the dice.

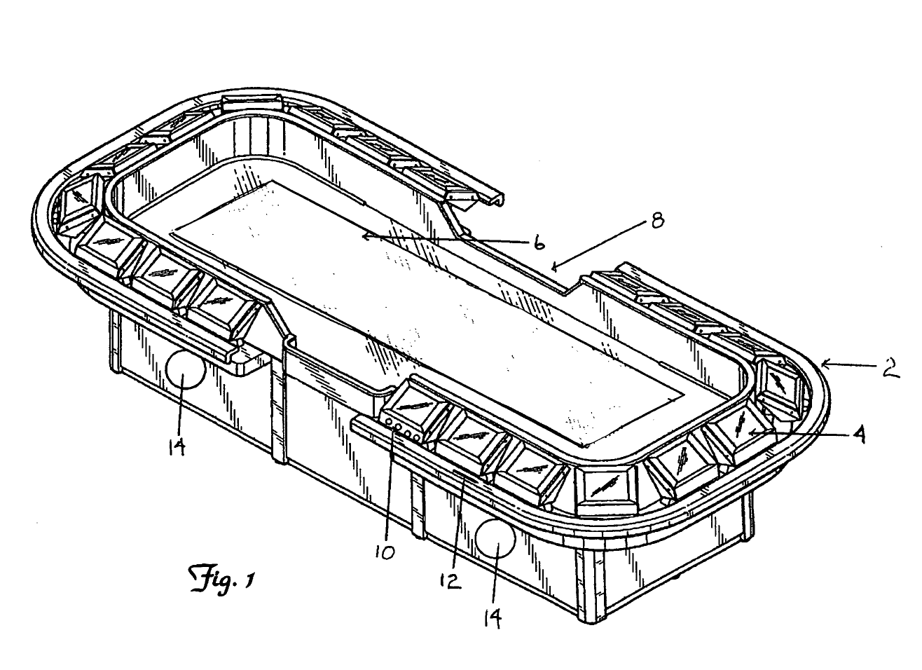

The technology of the present invention may be played on a stand alone (single player) video gaming system or preferably on a multiple player gaming system such as that illustrated in FIG. 1. The multi=player player format enables a more realistic simulation of a live dice game and enables players to interact with one another as occurs frequently in a live craps game.

FIG. 1 shows a first embodiment of a multiple player gaming table system 2, having twenty (20) individual player position monitors 4 with touch screen functionality. A simulated gaming table surface 6 is provided on which game outcomes, game instructions, rules, betting areas, pay scales, advertising and other printed information or decorations may be provided. As the surface is not actually involved in the game play (with neither chips nor dice having to be placed on the surface), the content on this surface is optional to an extent where the surface 6 may be optionally display features unrelated to the game, such as advertisements or video clips for entertainment purposes. Optionally the simulated gaming table surface 6 has a display showing a virtual representation of a traditional craps table layout (not shown), also visible to players at the position monitors 4. The display 6 can then show gaming information such as the current wagers of the players, a visual representation of the dice, historical game statistics and the like. Access opening 8 is also optional to provide both a feel for a normal Craps table and to reduce crowding at the table, allow easier access for restricted (e.g., wheel chair) players, and/or allow easier access to electronic (not shown) within the body of the table 2. Although touch screen input is important to the practice of the preferred technology described herein, optional player input button controls 10 are also shown.

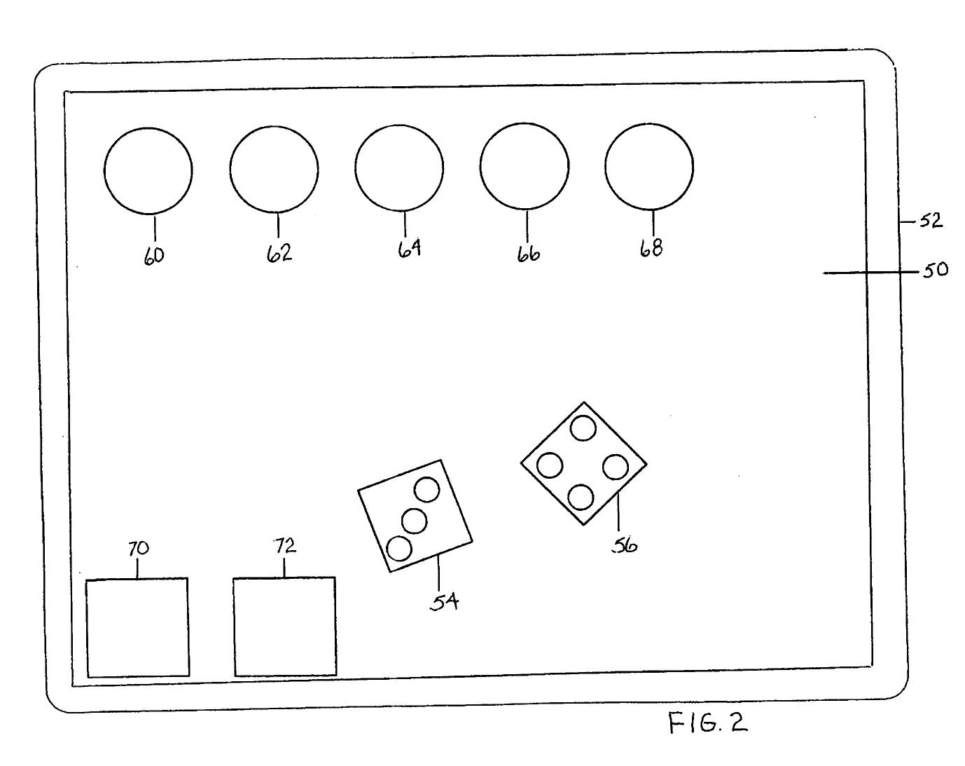

FIG. 2 shows a screen shot 50 on a player's monitor 52 showing dice 54, 56 before being virtually cast. The computerized gaming system supporting the play of the game is a video wagering game system, which displays information for at least one wagering game upon which monetary value can be wagered on the game through player input of wagering amounts and wagering placement, especially along the format of wagering entry disclosed in Applicant's copending U.S. patent application Ser. No. 11/595,541, filed Nov. 10, 2006, and titled MULTILEVEL BETTING STRUCTURE ON COMPLEX WAGERING ALTERNATIVES IN ELECTRONIC WAGERING SYSTEMS, which is incorporated herein in its entirety by reference. The video display monitor 52 is in various embodiments, a CRT display, a plasma display, an LCD display, a surface conducting electron emitter display, or any other type of display suitable for displaying electronically provided display information that can support touch screen functionality. As touch screen functionality is usually provided by a film overlaid on the monitor 52, substantially any system can be provided with this function, as long as the users do not apply excessive force to the touch screen. Player input controls 60, 62, 64, 66, and 68 are shown, as well as accounting display areas 70 and 72.

A wagering game is implemented using software within the wagering game system, such as through instructions stored on a machine-readable medium such as a hard disk drive or nonvolatile memory (not shown). In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering game is played and controlled with inputs such as various buttons 10 or via a touch screen overlay to video screen on the monitor 52.

Monetary value is typically wagered on the outcome of the games, such as with tokens, coins, bills, or cards that hold monetary value, but most preferably through a credit wagering system in which value has been displayed on a specific player monitor and the player at that monitor, through the use of the touch screen and/or button inputs can debit against available credit. The cash, token or credit card value may be conveyed to the machine through a currency or ticket acceptor or slot 12 or a secure user identification module interface in place of the slot 12, and winnings are returned via the returned value card, ticket, or less preferably through a coin tray (not shown). Sound may also be provided through speakers 14 (Shown in FIG. 1), typically including audio indicators of game play, such as dice rolling and hitting a wall, music, player conversation, cheering or other exclamations, and environmental or other sound effects or music to provide entertainment consistent with a theme of the computerized wagering game.

In some further embodiments, the wagering game machine is coupled to a network, and is operable to use its network connection to receive wagering game data, track players and monetary value associated with a player, and to perform other such functions.

Referring back to FIG. 1, the speakers 14 and the display monitor 4 are used in one example embodiment of the invention to provide information related to the wagering game to the game player, along with other information such as graphics or animation designed to entertain. The graphics may be accompanied by sounds, such as to indicate a game activity like awarding of credits (credit bang-up), or winning a game event, or activity by other players. Sounds in some embodiments change depending on the wagering game machine's mode, such as using one set of sounds in an attract mode designed to draw the attention of potential game players, another set of sounds during normal game play, and a third set of sounds during a winning event.

In various embodiments of the present invention, the sounds are also used to indicate a change of the point, effect of a roll within a particular point or roll, such as during regular game play.

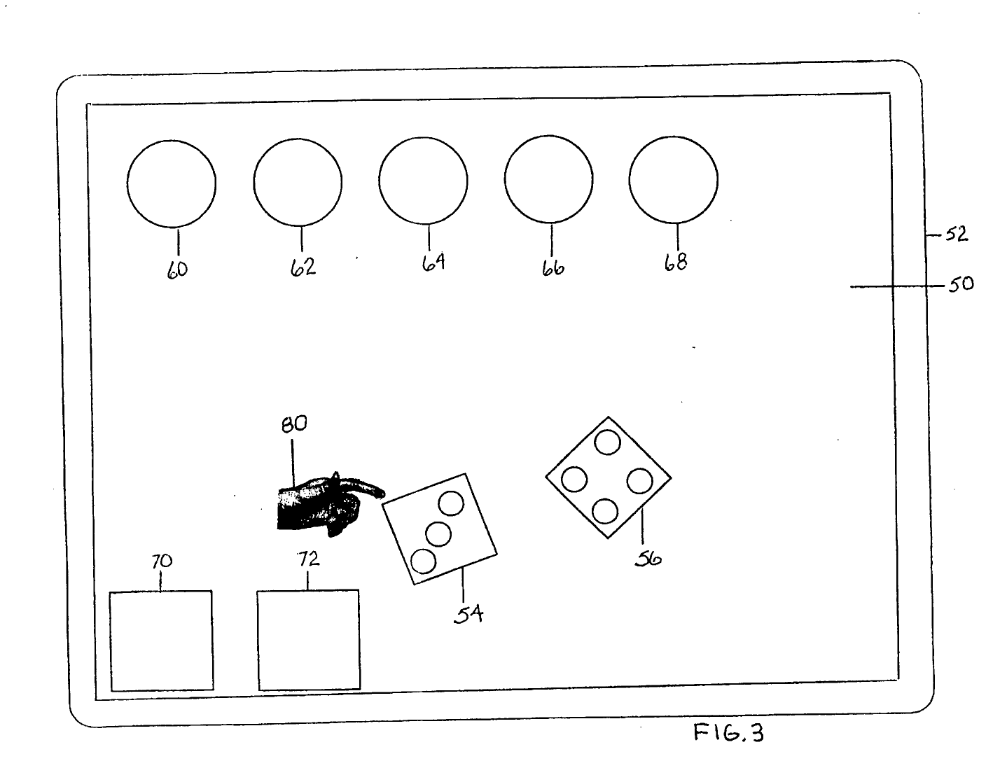

FIG. 3 shows a screen shot 50 on a player's monitor 52 showing dice 54, 56 in contact with a virtual hand 80 mimicking contact by a player's hand before the dice are virtually cast. The display of the virtual hand 80 is an optional feature of the present invention.

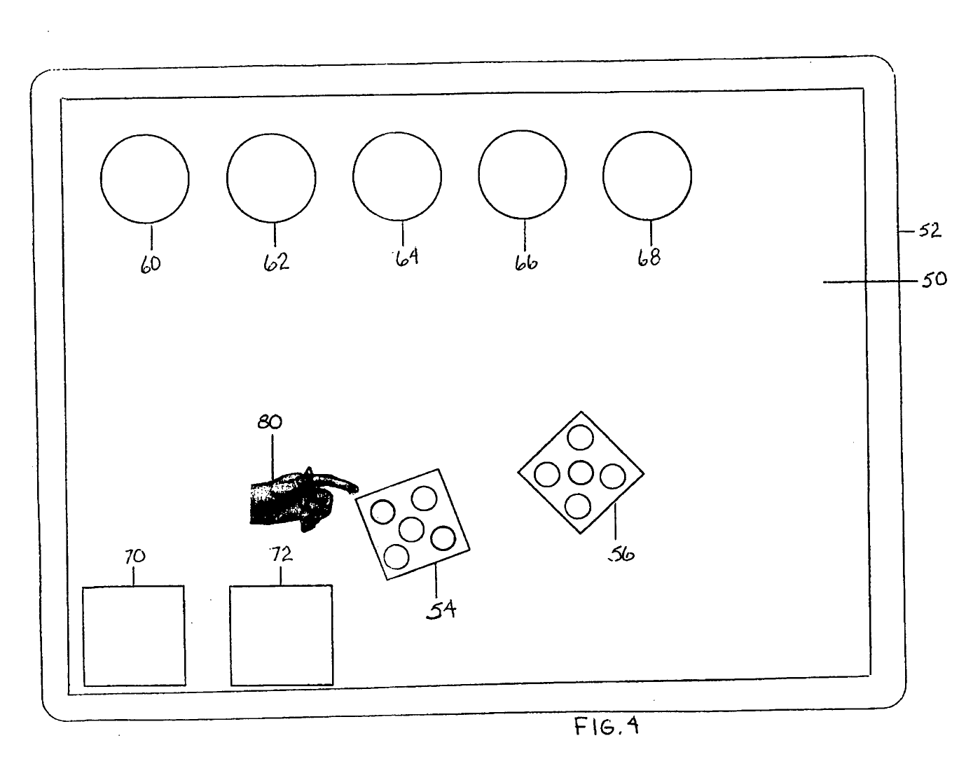

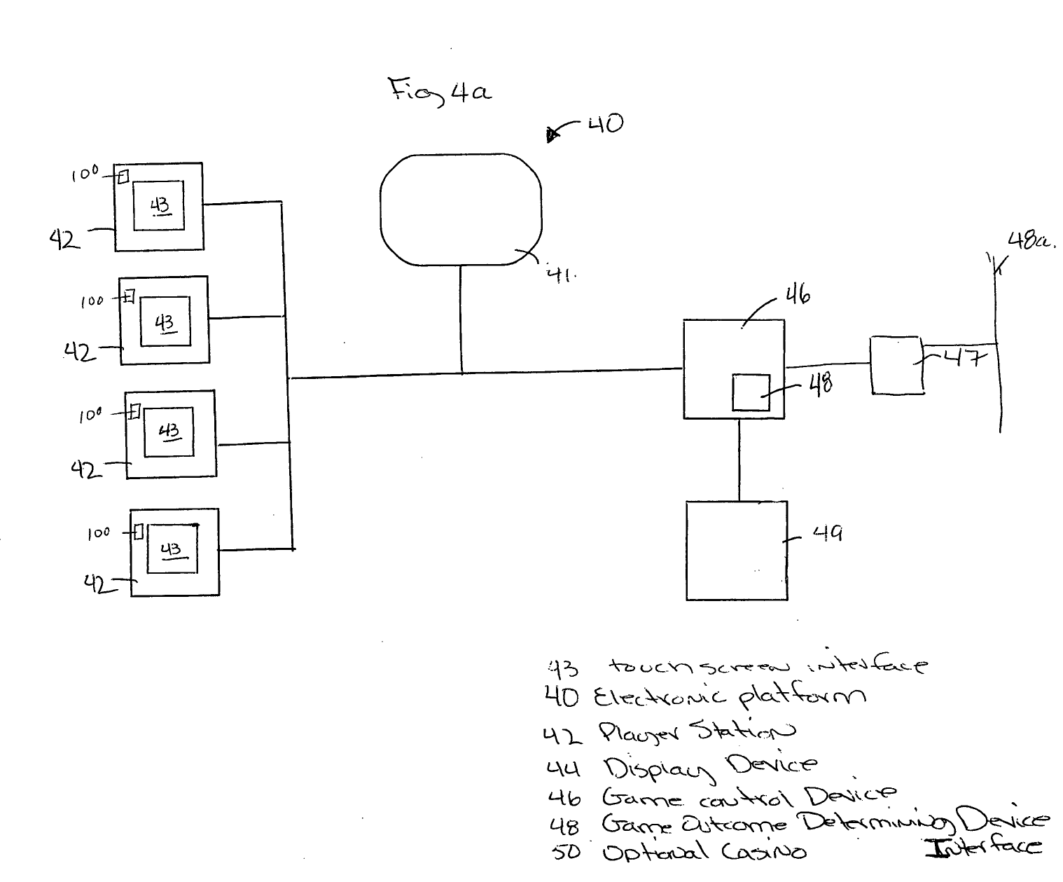

FIG. 4 shows a virtual player's hand 80 manipulating a stationary or preliminary position of the dice 54, 56 prior to casting the dice. It can be seen that the numbers on the face of the dice 54, 56 have changed from FIG. 3 because of the player-initiated virtual manipulation of the virtual dice prior to the dice toss.

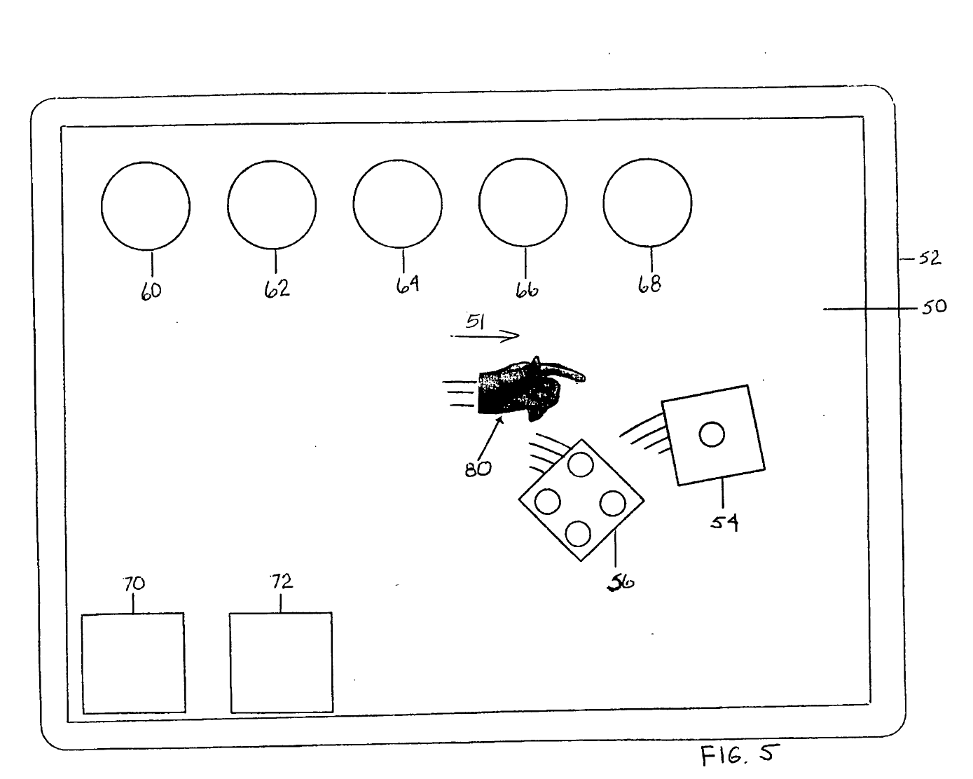

FIG. 5 shows a virtual hand moving as a result of a real hand (not shown) moving in contact with a touch screen 52 on a player's monitor 50 in a direction indicated by arrow 51 and initiating movement of the dice 54, 56.

An example of a suitable touch sensitive monitor 50 is a FPT-06410 VGA open frame touch sensitive monitor available from Caltron Industries of Fremont, Calif., and generates audiovisual data relating to betting parameters associated with the particular dice table game, advertising, table game events according to game progression (such as the value of a die roll, or the occurrence of a large payout event) and player activity information derived by the system of the present invention. Touch sensitive monitor 50 and possibly additionally the button assembly 10 in FIG. 1 (alternatively including joystick or “track ball” controls) allow data to be input by players for use in a table game system. In one exemplary embodiment, the keypad buttons 10 can be configured so that a predetermined key can be associated with one or more suitable functions relating to the table game system. Examples include a) positioning the dice prior to the roll, b) selecting the direction of the roll; and c) initiating the roll.

A stand alone video machine (not shown) for playing a dice game according to one embodiment would include a cabinet that houses a monitor (with touch screen functions), control buttons, and credit controls (e.g., a lockable box, currency acceptor, card acceptor, coin or token acceptor, etc.). The cabinet would also house a central processing unit (CPU) (not shown), data storage unit (e.g., a hard drive, ZIP drive, floppy drive, CD/DVD drive, tape drive, memory, etc.) (not shown), graphics card (not shown), and communication device (e.g., modem, network interface card, etc.) (not shown), among others.

A control system 40 for an embodiment of the present invention is shown in FIG. 4a. The control system 40 includes a game processor 46 with associated memory 48. The game processor communicates with multiple player terminals 42 and provides video output to the player displays 43. The terminals 42 in this embodiment include push button controls 100 and may also include other types of controls such as joysticks or trackballs as an alternative to providing touch screen controls.

The game controller 46 also provides video output to a common display 41. A dealer display 49 with dealer touch screen controls is provided to administer the game. The dealer controls may be used for administrative functions such as logging in, powering up, entering player information, assigning credits to players, calling for service, verifying a large jackpot, rebooting the system, and the like. Although it is preferred that the system operate without an attendant, some casino managers may prefer to provide an attendant to facilitate continued game play.

The game processor 46 may be in communication with a casino back-end interface 47 that is in turn in communication with a casino network 48a.

The system may also include a communication device, graphics card, etc. that are responsive to the CPU 46. A computer program, for example, having a module encoding the rules for the dice game and for determining a roll total, may reside on the data storage unit 48. The CPU 46 is operable, for example, to receive input (for example, from control buttons 100 or a touch screen control on the player display 43), execute the computer program residing on the data storage unit 48, and output results to the monitor 43 via the graphics card.

A working example of the play of the system of the present invention can be understood from comparison of FIGS. 2-5. One of the multiple players (or the only player) at a table 2 in FIG. 1, is designated by the software in the CPU as the first shooter. This can be effected by designating the first player to place credit into the next game, or have the roll progress according to normal Craps game rules, with a shooter continuing until sevening-out. After all wagers are made in FIG. 2, or at a time interval after a last wager was made by any player at the table, the virtual dice 54, 56 appear on the touch screen monitor 52. Numbers in the form of dots appear on the dice (in this case 3 dots and four dots), either randomly or as the last result of the roll of the dice.

In FIG. 3, a virtual hand 80 appears on the touch screen monitor 52 in response to a player touching the screen or automatically. The virtual hand 80 can be used first to adjust the position or numbering of the dice 54, 56 by virtually touching the dice or some other virtual mechanism. A simple format is to have the virtual hand touch each die to change the number on the die by one unit for each touch. The virtual hand 80 would move from one die 54 to another 56 to complete this task, the completed change of numbers being shown in FIG. 4. This is a highly emotional feature for craps players who like to feel that they are somehow controlling events by controlling or altering the initial configuration of dice before each roll. Once the dice are in the desired configuration, as shown in FIG. 4, the virtual hand 80 is shown sweeping across the monitor 52 in FIG. 5, in response to a player passing his or her hand across the screen thereby also casting the virtual dice 54, 56 which are shown moving and rotating. In these Figures, each same number in different Figures represents the same structural element.

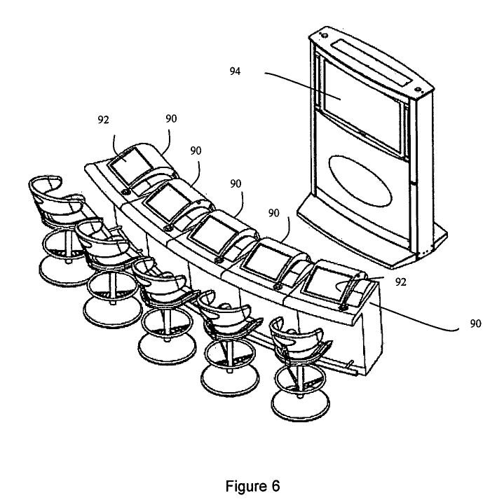

FIG. 6 shows an alternate embodiment of a multiple player gaming system according to the invention. As can be seen, FIG. 6 shows a plurality of player terminals 90. Each terminal includes a touch screen input 92 for allowing a player to place wagers and control the virtual dice as described above. The touch screen also displays information relating to the game. A communal screen 94 which can be seen by all players displays a virtual craps table (not shown) upon which the throw of the virtual dice is shown. The communal screen also shows additional information such as the bets of all the players wagering on the game and historical gaming information such as the outcome of the last 10 dice rolls, best shooter of the day, longest roll and the like. The operation of this embodiment is similar to that as described above and after placing bets, one of the players is designated as the shooter. The shooter sets up the dice in accordance with his/her preference and then casts the dice by dragging or swiping their hand across the touch screen input 92. The dice are then shown to leave the player's touch screen 92 and then enter onto the communal screen 94.

The physics of the virtual dice throw (such as the speed, direction, angle, height etc) may be or are determined by the player's interaction with the touch screen. For example, the speed at which the player touches the touch screen and/or moves the contact point with the touch screen affects the speed of the throw. The faster the players hand (preferably fingers) moves across the screen the faster the dice will be thrown. The direction in which the player runs their finger across the touch screen determines the direction in which the dice will be thrown. The height of the throw (i.e., the height above the playing surface of the table) can be determined by which portion of the screen is touched. For example, the screen can be split into thirds with the top third representing a high looping dice throw, the middle section representing an average height throw and the bottom section representing a throw in which the dice are low and close to the table. Other physics of the throw can be defined as required. The device may even be programmed to show that dice were thrown off the table, as often happens in a live game. A predetermined number of graphics sequences showing the dice being rolled can be stored within the system with the particular sequence displayed on the communal display being chosen according to the player's interaction with the touch screen.

Embodiments of the present invention include “atmosphere” audio features. These features are designed to make the simulation more realistic and to add additional entertainment value. An artificial group response and an artificial group environment is created through at least sound (audio) additions to the logic and software that is responsive to play activity. For example, as more people enter the game, the simulated sounds of excitement become louder and more voices/sounds are added to compliment the existing atmosphere of the table.

A series of sound files are stored in the system and are played at appropriate times (prior to throws, during the betting period, on the completion of a throw, etc.). The sounds may differ in content and volume. For example, if there were 25 sounds, sound 1 (lowest) may include low level cheer of a couple of people once a favourable result comes out, while sound 25 is of high volume with a large crowd cheering and whistling. In one embodiment, negative sounds are played if a detrimental event occurs.

The Table below is an example of using these sounds based on just 2 variables listed (length of games, number of players) and details the sound to be played on the completion of a positive roll of the dice (game not ended, point made, hardway thrown, etc.). These variables may be extended to include the time of day, day of the week or season. Sounds may also be customised to take into account particular locations with the introduction of music and other sound files depending on creative requirements.

| | Length of game | | | | | |
|---|---|---|---|---|---|---|
| Players | 1-2 rolls | 3-4 rolls | 5-7 rolls | 8-10 rolls | 11-15 rolls | 16+ rolls |
| 1 | Sound 1 | Sound 2 | Sound 3 | Sound 5 | Sound 7 | Sound 10 |
| 2 | Sound 2 | Sound 3 | Sound 4 | Sound 7 | Sound 9 | Sound 12 |
| 3 | Sound 3 | Sound 4 | Sound 6 | Sound 9 | Sound 11 | Sound 14 |
| 4 | Sound 4 | Sound 5 | Sound 7 | Sound 11 | Sound 13 | Sound 16 |
| 5 | Sound 5 | Sound 6 | Sound 9 | Sound 13 | Sound 15 | Sound 18 |
| X − 1 | Sound 6 | Sound 7 | Sound | Sound 15 | Sound 18 | Sound 20 |
| | | | 10 | | | |
| X | Sound 7 | Sound 9 | Sound | Sound 17 | Sound 21 | Sound 25 |
| | | | 12 | | | |

In a preferred embodiment, similar matrices would be constructed for different sound requirements using the same variables. Other sound groupings may include the end of the game (e.g., negative sound of crowd moaning etc., a large payoff throw or a new thrower). As can be seen in the example matrix below, any suitable variable or event and number of conditions can be used to create a matrix of sounds that will be played at the required time.

| | Variable 2 | | | | | |
|---|---|---|---|---|---|---|
| Variable 1 | Condition A | Condition B | Condition C | Condition D | Condition E | Condition F |
| Condition 1 | Sound 1′ | Sound 2′ | Sound 3′ | Sound 5′ | Sound 7′ | Sound 10′ |
| Condition 2 | Sound 2′ | Sound 3′ | Sound 4′ | Sound 7′ | Sound 9′ | Sound 12′ |
| Condition 3 | Sound 3′ | Sound 4′ | Sound 6′ | Sound 9′ | Sound 11′ | Sound 14′ |
| Condition 4 | Sound 4′ | Sound 5′ | Sound 7′ | Sound 11′ | Sound 13′ | Sound 16′ |
| Condition 5 | Sound 5′ | Sound 6′ | Sound 9′ | Sound 13′ | Sound 15′ | Sound 18′ |
| Condition 6 | Sound 6′ | Sound 7′ | Sound 10′ | Sound 15′ | Sound 18′ | Sound 20′ |
| Condition 7 | Sound 7′ | Sound 9′ | Sound 12′ | Sound 17′ | Sound 21′ | Sound 25′ |

The creation of “atmosphere” is not limited to the selection and play of sound files. Atmosphere may include vibration of all or part of the player station, emission of aromatic substances, fog machines, misting systems and the like.

Sound files are preferably played through the hardware with speakers placed in key areas so as to not negatively impact individual players. Preferably the sound volume can be controlled and/or overridden by the operator. Some examples of the components of the invention include bass speakers and an amplifier. The system may include large bass speakers under the system such that the inclusion of sound would also create a vibration around the table. Amplifiers in one embodiment are provided to direct sound to different speakers at key times. Some speakers would be spaced apart from the actual table so as to promote the game to passing traffic, and not be directed at players

There are a number of modifications made to current software and/or hardware and mathematical models that is required to integrate this aspect of the invention into current products or new products. Listed below are examples of changes in software and/or hardware to implement the “atmosphere” features of the present invention:

Speakers suspended above the table with the LCD Screens to give surround sound of high and mid frequencies to generate a tempo in the game for player excitement.

Sub Woofer under the crap table for the low frequency sound to generate a slight vibration and give life to the table that the players can feel.

Wireless transmitter and receiver so additional speakers can be placed anywhere around the table or wherever a customer would like to place a display system for advertising of the game etc.

Amplifier used to boost the signal at various points in the game. Sound will be increased at certain intense moments of the game play and decreased in quieter moments.

Mixer to mix sound frequency between sub woofer and smaller mounted speakers to give maximum impact at varying important intervals during the game cycle.

Intelligent interface is situated between the game playing peripherals and the Sound/Display system. This interface will interpret the “atmosphere” of the game at certain intervals generated by results, player runs etc. This interface will then play different sounds and increase or decrease sound volumes depending on the event and/or results leading up to the event. This can also be manually overridden and run by the operator depending on requirements.

The artificial atmosphere can also be used in dealer operated games of craps that may include electronic betting. For example, the system disclosed in applicant's Australian Patent Application No. 2006235950 entitled “Automatic Dice Game” filed 10 Nov. 2006 is incorporated herein in its entirety by way of reference.

Although specific examples, numbers, games and images are provided in the description above, one skilled in the electronic table gaming art would recognize the variations and alternatives that can be used within the generic scope of the disclosed technology and still fall within the scope of inventions claimed herein.

What is claimed:

1. An electronic video gaming system comprising:
a processor,
at least one player console, the console comprising
a video screen,
player credit controls or wager input system, and
player controls for player input on the video screen, and
wherein after at least one player has placed a wager in a wagering game, at least one player at the video game is designated a shooter, and while a virtual image of dice appears on a screen, the virtual image of the dice is responsive to the player's use and the player controls, wherein the player initiates an image of a dice roll in the wagering game.

2. The electronic video gaming system of claim 1 wherein the player controls are touch screen controls and wherein the image of the dice is also sensitive to contact and hand movement of a player to adjust numbers appearing on the virtual image of the dice prior to the dice roll in the wagering game.

3. The electronic video wagering system of claim 1, wherein the player controls are touch screen controls and wherein the hand movement used to initiate an image of a dice roll to which the touch functions are sensitive comprises sliding a player's hand across the video screen.

4. The electronic video system of claim 1 wherein the processor exercises a random number generated algorithm to simulate random rolls of the dice.

5. The electronic video wagering system of claim 2 wherein the hand movement used to initiate an image of a dice roll to which the touch functions are sensitive comprises sliding a player's hand across the video screen.

6. The electronic video system of claim 1 wherein multiple touch screen monitors are positioned at a single gaming table and each player at each monitor can play a communal dice wagering game using the results of the dice roll to determine a common dice outcome for all players.

7. The system of claim 1, wherein multiple player consoles are provided and further comprising a common game outcome display spaced apart from at least one of the player consoles.

8. The electronic system of claim 6 wherein the processor allows only a single touch screen monitor at a given time to be able to control movement of the virtual dice in the dice wagering game.

9. The electronic video system of claim 1 wherein the processor identifies numbers of active players at a table and varies sound effects to the players in approximate accordance to a volume consistent with the determined number of players.

10. A method of playing a video wagering game in which dice are displayed as a game event comprising:
placing a wager on the video game,
providing an image of at least one die on a touch sensitive video screen,
a player contacting the image of the at least one die on the video screen,
moving the contact with the image of the at least one die to initiate an image of the at least one die being cast; and
using a resulting number on a virtual image of the cast die after it comes to rest as a game determining outcome.

11. The method of claim 10 wherein the wagering game comprises craps.

12. The method of claim 11 wherein multiple player monitors are provided to simulate a craps game with multiple players.

13. The method of claim 12 wherein before initiating an image of at least one die being cast, contact with the virtual image of the at least one die is used to position a particular number on the at least one die before the initiating.

14. The method of claim 12 wherein before initiating an image of at least one die being cast, contact with the virtual image of the at least one die is used to position a particular number on the at least one die before the initiating.

15. The method of claim 12 wherein a processor executes game code in playing the video wagering game.

16. The method of claim 15 wherein the processor determines numbers of players at a table.

17. The method of claim 16 wherein the processor initiates sound effects through speakers associated with a single multiple player craps game table.

18. The method of claim 17 wherein the sound effects are selected from a set of files on a basis including simulating sounds consistent with a determined number of players at the single multiple player game table.

19. The method of claim 12 wherein the processor allows only a single touch screen monitor at a time to be able to control virtual dice movement.

20. The method of claim 19 wherein after the single player sevens-out, the processor deactivates the touch screen control of the dice for that player and activates a touch screen monitor of another player to be able to control virtual dice movement.

21. The method of claim 18 wherein the sound effects are further selected from a set of files on a basis including simulating sounds consistent with the outcome of the game.

22. A gaming system having a simulated atmosphere, the gaming system comprising:
a gaming table having gaming apparatus for determining a random outcome;
a game processor for receiving electronic signals regarding the result of the random outcome; and
at least one sensory simulator in communication with the game processor for creating the simulated atmosphere, at least one characteristic of the simulated atmosphere being dependent on the result of the random outcome.

23. A gaming system according to claim 22 wherein the apparatus for manually determining a random outcome is at least one video representation of at least one die which is rolled and whose outcome is displayed.
